(19) United States
(12) Patent Application Publication
(10) Pub. No.: US 2025/0041975 A1
(43) Pub. Date: Feb. 6, 2025

(54) LASER SLICING APPARATUS

(71) Applicant: Industrial Technology Research Institute, Hsinchu (TW)

(72) Inventors: Jyun-Jhih WANG, Hsinchu (TW); Chun-Ming CHEN, Hsinchu (TW); Yu-Chung LIN, Hsinchu (TW); Pin-Hao HU, Hsinchu (TW); Chien-Jung HUANG, Hsinchu (TW)

(73) Assignee: Industrial Technology Research Institute, Hsinchu (TW)

(21) Appl. No.: 18/464,438

(22) Filed: Sep. 11, 2023

(30) Foreign Application Priority Data
Jul. 31, 2023 (TW) 112128702

(51) Int. Cl. B23K 26/53; B23K 26/06; B23K 26/067; B23K 26/08

(52) U.S. Cl. CPC B23K 26/53; B23K 26/0648; B23K 26/0676; B23K 26/083

(57) ABSTRACT

A laser slicing apparatus, in which a laser module provides a laser beam, and a light splitting element of a focusing lens set splits the laser beam into a plurality of focused laser beams to form a plurality of induce lines having first laser modified cracks in a modified layer at a predetermined depth inside a substrate. A rotating module rotates the light splitting element with an angle, and the light splitting element converts the focused laser beams according to this angle to form a plurality of modified groups between the induce lines. Each modified group includes a plurality of modified lines having second laser modified cracks, and the first laser modified cracks and the second laser modified cracks are connected to each other to form a continuous laser modified crack in the modified layer at the predetermined depth inside the substrate, thereby speeding up the laser slicing production.

### BACKGROUND

### 1. Technical Field

The present disclosure relates to a laser slicing technology, and more particularly, to a laser slicing apparatus.

### 2. Description of Related Art

At present, diamond wire saw cutting technology is used by most international mainstreams to cut a thick substrate (such as a crystal ingot) directly from the horizontal direction (such as the X-axis direction or the Y-axis direction) into a plurality of thin slices (such as wafers). However, such diamond wire saw cutting technology would simultaneously cause material loss such as cutting loss and grinding and polishing loss of the substrate.

For example, using diamond wire saw cutting technology to cut a thin slice (such as a wafer) with a thickness of about 350 microns (μm) from a substrate (such as a crystal ingot) may cause a cutting loss and grinding and polishing loss of a thickness of about 260 μm on the substrate. Therefore, cutting out a thin slice from the substrate is almost equal to losing another thin slice, resulting in a very high cost of the substrate.

In this regard, some relevant companies have begun to develop laser slicing technology and use laser beams to slice the interior of the substrate (such as a crystal ingot), so that a plurality of thin slices (such as wafers) can be separated from the substrate. However, there is still much room for improvement in this laser slicing technology.

FIG. 1A to FIG. 1B are schematic diagrams of general laser slicing technology, wherein FIG. 1B is a schematic diagram of a modified layer B1 at a predetermined depth inside a substrate B (such as a crystal ingot) in FIG. 1A.

As shown in FIG. 1A to FIG. 1B, the modified layer B1 at the predetermined depth inside the substrate B can be defined with a plurality (a large number) of laser modified tracks C, and an interval W between two adjacent ones of the laser modified tracks C can be about 25 microns (μm). In the meanwhile, this laser slicing technology can use a laser module A to generate a single laser beam A1, so that the single laser beam A1 can slowly and sequentially pass through or focus on different positions of the plurality of laser modified tracks C of the modified layer B1 inside the substrate B, and the heat energy generated by the single laser beam A1 of the laser module A will expand the lattice at different positions of the plurality of laser modified tracks C to form a plurality of laser modified cracks C1, such that a thin slice B2 (such as a wafer) of the substrate B and a portion B3 to be separated can be separated from the plurality of laser modified cracks C1 of the modified layer B1 in the subsequent process.

However, this laser slicing technology uses the plurality of laser modified tracks C to fill the processing path of the modified layer B1 inside the substrate B and can only provide a single laser beam A1 of the laser module A to slice the plurality of laser modified tracks C of the modified layer B1, so the growth or extension (such as the growth range or extension length) of the laser modified cracks C1 of the plurality of laser modified tracks C is easily to be limited, and the laser slicing production rate or laser slicing process of the modified layer B1 inside the substrate B are appeared to be rather slow and time-consuming.

For example, if a 4-inch substrate B (such as a silicon carbide ingot) is processed with the single laser beam A1 of the laser module A, then the required laser slicing time for this laser slicing technology to perform laser slicing on the modified layer B1 inside the substrate B is about 10 hours per slice. In addition, if a substrate B over 4 inches is processed with the single laser beam A1 of the laser module A, then the required laser slicing time for this laser slicing technology to perform laser slicing on the modified layer B1 inside the substrate B will be even longer (more than 10 hours per slice), so a lot of time will be consumed.

Therefore, how to provide an innovative laser slicing technology to solve any of the above problems or provide a related laser slicing apparatus and method thereof has become a major research topic for those skilled in the art.

### SUMMARY

The present disclosure provides a laser slicing apparatus, which comprises: a laser module for providing a laser beam; a focusing lens set having a light splitting element to split the laser beam provided by the laser module into a plurality of focused laser beams, wherein the plurality of focused laser beams split by the light splitting element of the focusing lens set are used to form a plurality of induce lines having first laser modified cracks in a plurality of different positions of a modified layer at a predetermined depth inside a substrate; and a rotating module for rotating the light splitting element of the focusing lens set by a predetermined angle, wherein the plurality of focused laser beams split by the light splitting element of the focusing lens set are converted into a plurality of modified groups between the plurality of induce lines of the modified layer at the predetermined depth inside the substrate according to the predetermined angle rotated by the rotating module, and each of the modified groups includes a plurality of modified lines having second laser modified cracks formed by the plurality of focused laser beams of the light splitting element of the focusing lens set, so that the first laser modified cracks of the plurality of induce lines and the second laser modified cracks of the modified lines of the plurality of modified groups are connected to each other to together form a continuous laser modified crack in the modified layer at the predetermined depth inside the substrate, such that the speed of laser slicing can be accelerated by the laser slicing apparatus.

The present disclosure provides a laser slicing method, which comprises: providing a laser beam by a laser module, and splitting the laser beam provided by the laser module into a plurality of focused laser beams by a light splitting element of a focusing lens set, and then forming a plurality of induce lines having first laser modified cracks in a plurality of different positions of a modified layer at a predetermined depth inside a substrate by using the plurality of focused laser beams split by the light splitting element of the focusing lens set; and rotating the light splitting element of the focusing lens set with a predetermined angle by a rotating module, wherein the plurality of focused laser beams split by the light splitting element of the focusing lens set are converted into a plurality of modified groups between the plurality of induce lines of the modified layer at the predetermined depth inside the substrate according to the predetermined angle rotated by the rotating module, and each of the modified groups includes a plurality of modified lines having second laser modified cracks formed by the plurality of focused laser beams of the light splitting element of the focusing lens set, so that the first laser modified cracks of the plurality of induce lines and the second laser modified cracks of the modified lines of the plurality of modified groups are connected to each other to together form a continuous laser modified crack in the modified layer at the predetermined depth inside the substrate.

Therefore, the present disclosure provides an innovative laser slicing apparatus and method thereof, in which a laser beam is provided from the laser module to the light splitting element of the focusing lens set to be split into a plurality of focused laser beams, so that the plurality of induce lines having the first laser modified cracks are formed in the modified layer inside the substrate, and then the plurality of modified lines having the second laser modified cracks and the modified groups (multiple lines in one group) are formed between the plurality of induce lines according to the predetermined angle rotated by the rotating module, such that the combination of the laser module, the focusing lens set having the light splitting element and the rotating module can be properly used, thereby effectively increasing the laser slicing production rate of the modified layer inside the substrate. A modified pattern formed by the above-mentioned laser slicing apparatus and method of the present disclosure is also proposed.

Alternatively, in the present disclosure, the plurality of induce lines having the first laser modified cracks can be formed (processed) via a plurality of focused laser beams in the modified layer at the predetermined depth inside the substrate to guide or control the growth of the laser modified cracks. Then, the light splitting element of the focusing lens set is rotated by the rotating module to form (process) the plurality of modified lines having the second laser modified cracks and the modified groups (multiple lines in one group) via the plurality of focused laser beams to expand the extension of the laser modified cracks, so that a stable continuous laser modified crack in the modified layer inside the substrate can be formed, and the laser slicing time or laser processing time of the modified layer inside the substrate can also be greatly reduced.

Alternatively, the present disclosure can effectively guide or control the growth of the plurality of first and second laser modified cracks in the modified layer at the predetermined depth inside the substrate via the plurality of induce lines to form a continuous laser modified crack, and can also make the substrate (the modified layer) have a better (such as lower, smoother) surface roughness by the plurality of induce lines, and can also reduce the grinding and polishing loss of the substrate (the modified layer).

In order to make the above-mentioned features and advantages of the present disclosure more comprehensible, the following specific embodiments are described in detail together with the accompanying drawings. Additional features and advantages of the disclosure will be set forth in the description which follows, and in part will be learned from the description, or may be learned by practice of the disclosure. It is to be understood that both the foregoing general description and the following detailed description are exemplary and explanatory in nature and are not intended to limit the scope of the disclosure as it is intended to be claimed.

### BRIEF DESCRIPTION OF THE DRAWINGS

FIG. 1A to FIG. 1B are schematic diagrams of general laser slicing technology, wherein FIG. 1B is a schematic diagram of a modified layer at a predetermined depth inside a substrate in FIG. 1A.

FIG. 2A to FIG. 2B are schematic structural diagrams illustrating an embodiment of a laser slicing apparatus of the present disclosure.

FIG. 3A is a schematic diagram illustrating an embodiment of the laser slicing apparatus shown in FIG. 2A of the present disclosure, and FIG. 3A shows that a plurality of induce lines are formed in a modified layer at a predetermined depth inside a substrate by using a plurality of focused laser beams.

FIG. 3B is a schematic diagram illustrating an embodiment of the laser slicing apparatus shown in FIG. 2B of the present disclosure, and FIG. 3B shows that a plurality of modified groups having modified lines (multiple lines in one group) are formed between the plurality of induce lines by using the plurality of focused laser beams.

FIG. 4 is a flowchart illustrating an embodiment of a laser slicing method of the present disclosure.

FIG. 5 is a schematic diagram illustrating another embodiment of the laser slicing apparatus and method thereof shown in FIG. 2A to FIG. 2B of the present disclosure, and FIG. 5 shows that the plurality of modified groups having the modified lines (multiple lines in one group) are formed between the plurality of induce lines by using the plurality of focused laser beams.

FIG. 6 is a schematic diagram illustrating an embodiment of the laser slicing apparatus and method thereof of the present disclosure, and FIG. 6 shows that the thin slice of the substrate is separated from the modified layer after forming the plurality of induce lines and modified groups (the modified lines) in the modified layer at the predetermined depth inside the substrate as shown in FIG. 3B.

### DETAILED DESCRIPTION

Implementations of the present disclosure are described below by embodiments. Other advantages and technical effects of the present disclosure can be readily understood by one of ordinary skill in the art upon reading the disclosure of this specification.

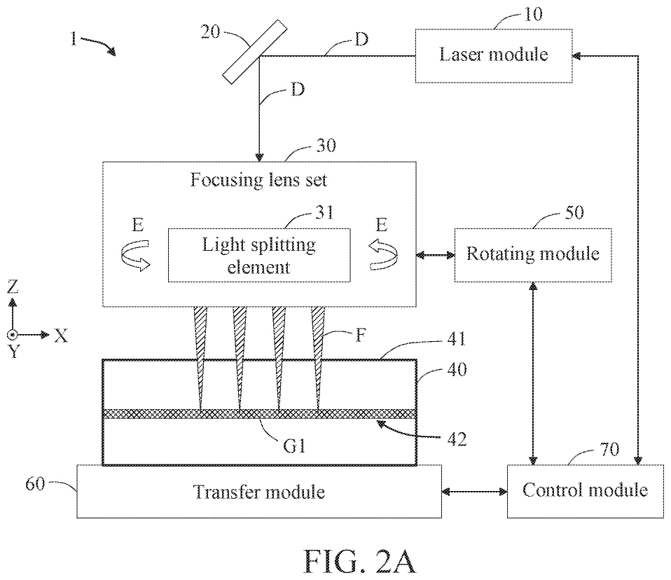

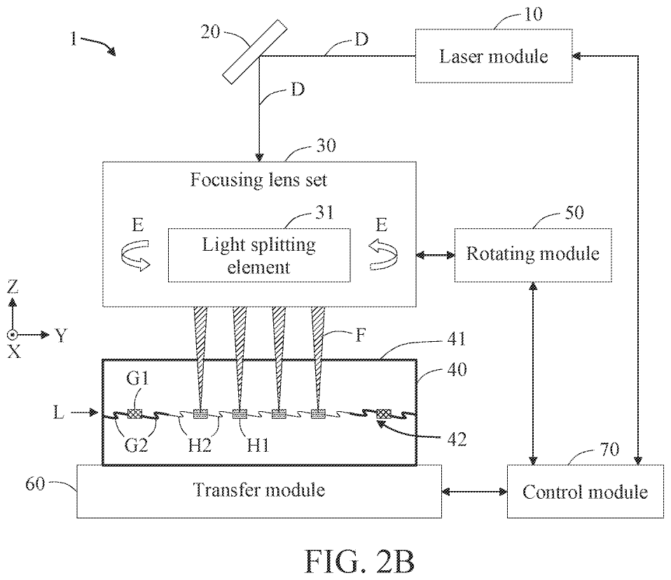

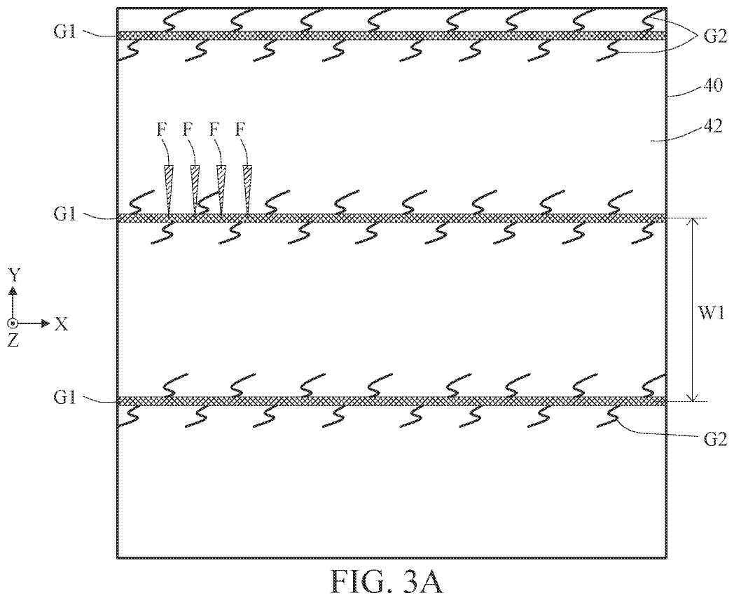

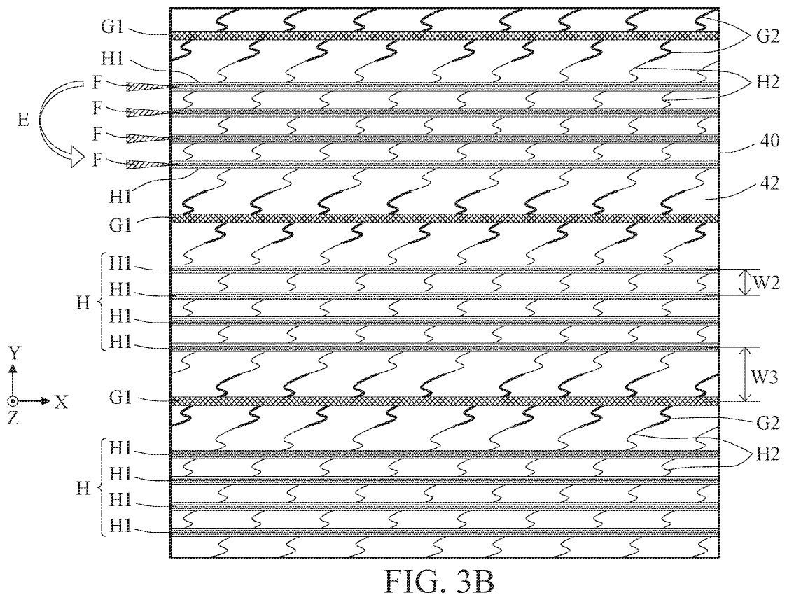

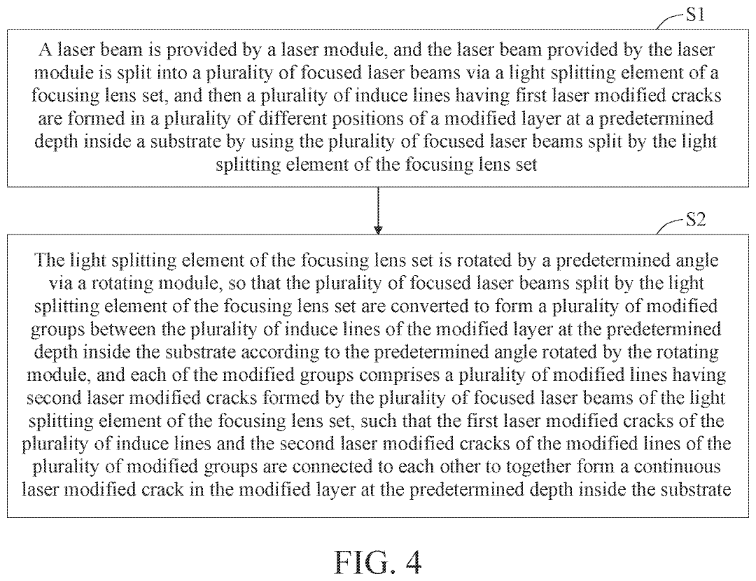

FIG. 2A to FIG. 2B are schematic structural diagrams illustrating an embodiment of a laser slicing apparatus 1 of the present disclosure. FIG. 3A is a schematic diagram illustrating an embodiment of the laser slicing apparatus 1 shown in FIG. 2A of the present disclosure, and FIG. 3A shows that a plurality of parallel or nearly parallel induce lines G1 are formed in a modified layer 42 at a predetermined depth inside a substrate 40 by using a plurality of focused laser beams F. FIG. 3B is a schematic diagram illustrating an embodiment of the laser slicing apparatus 1 shown in FIG. 2B of the present disclosure, and FIG. 3B shows that a plurality of modified groups H having parallel or nearly parallel modified lines H1 (multiple lines in one group) are formed between the plurality of induce lines G1 by connecting the focal points of the plurality of focused laser beams F. FIG. 4 is a flowchart illustrating an embodiment of a laser slicing method of the present disclosure.

As shown in FIG. 2A to FIG. 2B, the laser slicing apparatus 1 of the present disclosure can have a higher laser slicing production rate and a lower laser slicing time, and the laser slicing apparatus 1 includes a laser module 10, an optical path conducting module 20, a focusing lens set 30, a rotating module 50, a transfer module 60 and a control module 70. The focusing lens set 30 can, for example, have a light splitting element 31. The rotating module 50 can be rotated, coupled, or connected (such as electrically or communicatively connected) with the focusing lens set 30 with or without the light splitting element 31, and the rotating module 50 can be disposed inside or outside the focusing lens set 30. The transfer module 60 can carry and move the substrate 40, and the control module 70 can control, couple, or connect (such as electrically or communicatively connect) the laser module 10, the rotating module 50 and the transfer module 60. All the modules mentioned above normally are hardware and may consist of optical parts, electric motors, actuators, drives, screws, circuit boards and so on.

In one embodiment, the laser module 10 (or the laser source) can be a laser generator or a laser emitter such as an ultraviolet laser, a semiconductor green laser, a near-infrared laser, or a far-infrared laser, and a laser beam D provided by the laser module 10 can be a laser pulse beam or the like. The optical path conducting module 20 can be an optical element, an optical lens, a light guide arm, an optical fiber, or any combination thereof, and the optical lens can be a reflector or the like. The light splitting element 31 can be a multi-beam diffractive optical element (DOE) or the like.

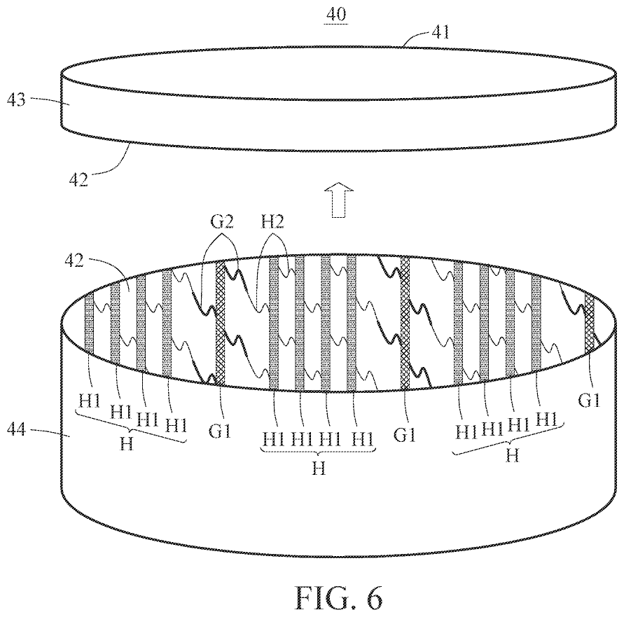

In one embodiment, the substrate 40 can be a substrate, a crystal ingot, a test chip, etc. made of silicon carbide (SiC), gallium nitride (GaN), gallium arsenide (GaAs), or silicon (Si). For example, the substrate 40 can be a silicon carbide (SiC) substrate, a gallium nitride (GaN) substrate, a gallium arsenide (GaAs) substrate, a silicon (Si) substrate, etc. A surface 41 of the substrate 40 can be the upper surface, etc., the modified layer 42 inside the substrate 40 can be a modified region or a laser modified layer, etc., and a thin slice 43 of the substrate 40 (as shown in FIG. 6) can be the separated part of the substrate, crystal ingot, or test chip composed of silicon carbide (SiC), gallium nitride (GaN), gallium arsenide (GaAs), or silicon (Si). For example, the thin slice 43 can be a silicon carbide (SiC) wafer, a gallium nitride (GaN) wafer, a gallium arsenide (GaAs) wafer, a silicon (Si) wafer, etc. The shape of the substrate 40 or the thin slice 43 can be circular, quadrilateral, etc., and the quadrilateral can be rectangular or square.

In one embodiment, the rotating module 50 can be a rotation driver, a rotation mechanism, and the like. The transfer module 60 can be a moving platform, a moving part, or a movable carrying platform, a carrier, etc., wherein the moving platform can be a precision moving platform, a three-axis moving platform (such as an XYZ three-axis moving platform), and the like. The control module 70 can be a controller (such as a microcontroller), a processor (such as a microprocessor, a central processing unit), a computer, a server (such as a central, remote, cloud, network server), a control circuit and software (control program), etc. The induce line G1 can be a laser induce line, etc., and the modified line H1 can be a laser modified line, etc. The above-mentioned induce line G1 and modified line H1 are formed when the slicing process is performed on the substrate 40, and the processing conditions of the formation thereof, such as power, frequency, feed speed, etc., may be the same or different, but the present disclosure is not limited to as such.

In one embodiment, “at least one” in the present disclosure represents one or more (such as one, two, three or above), and “plurality” represents two or more (such as two, three, four, five, ten, one hundred or above). However, the present disclosure is not limited to those mentioned in each embodiment.

As shown in FIG. 2A, FIG. 3A and step S1 of FIG. 4, the laser beam D is provided by the laser module 10, and the laser beam D provided by the laser module 10 is split into the plurality of focused laser beams F by the light splitting element 31 of the focusing lens set 30, and then the plurality of focused laser beams F split by the light splitting element 31 of the focusing lens set 30 are used to form the plurality of induce lines G1 having first laser modified cracks G2 in a plurality of different positions of the modified layer 42 at the predetermined depth inside the substrate 40 until the plurality of induce lines G1 cover the whole layer surface of the modified layer 42. For example, if the focusing lens set 30 does not have the light splitting element 31, the rotating module 50 can be inactive or disassembled, and only a single focused laser beam F is used for slicing process, but the present disclosure is not limited to as such.

That is, the laser module 10 (such as the laser source) can provide (such as generate, emit) at least one laser beam D, so that the laser beam D provided by the laser module 10 can be conducted by the optical path conducting module 20 to the focusing lens set 30 having the light splitting element 31. Then, the light splitting element 31 of the focusing lens set 30 can correspond to the surface 41 (such as the upper surface) of the substrate 40, so that the laser beam D provided by the laser module 10 or conducted by the optical path conducting module 20 is split (separately focused) into the plurality (for example, four) focused laser beams F by the light splitting element 31 of the focusing lens set 30 via the beam-splitting focusing method. Then, the plurality of focused laser beams F split by the light splitting element 31 of the focusing lens set 30 can pass through the surface 41 (such as the upper surface) of the substrate 40 along the same path in the vertical direction (such as the Z-axis direction), and then the plurality of focused laser beams F are successively (sequentially) focused in the plurality of different positions of the modified layer 42 at the predetermined depth inside the substrate 40 according to a predetermined first interval W1, so that the plurality of induce lines G1 spaced first interval W1 apart from each other and having the first laser modified cracks G2 (such as the bidirectional laser modified cracks) are successively (sequentially) formed in the plurality of different positions of the modified layer 42 at the predetermined depth inside the substrate 40 by the plurality of focused laser beams F, such that the light splitting element 31 of the focusing lens set 30 increases the laser slicing production rate of the modified layer 42 inside the substrate 40.

The predetermined depth inside the substrate 40 can be determined by the thickness of the thin slice 43 of the substrate 40 (as shown in FIG. 6), and the plurality of different positions of the modified layer 42 inside the substrate 40 can be different rows, different columns, or different regions of the modified layer 42, etc.

For example, as shown in FIG. 2A and FIG. 3A, the plurality (such as four) of focused laser beams F split by the light splitting element 31 of the focusing lens set 30 can together form an induce line G1 (as shown in the upper side of FIG. 3A) having the first laser modified cracks G2 (such as the bidirectional laser modified cracks) in a first position (such as the first row in the X-axis direction) of the modified layer 42 at the predetermined depth inside the substrate 40, and then the plurality (such as four) of focused laser beams F split by the light splitting element 31 of the focusing lens set 30 can together form another induce line G1 (as shown in the middle of FIG. 3A) spaced first interval W1 apart from the induce line G1 of the first position and having the first laser modified cracks G2 in a second position (such as a second row in the X-axis direction) of the modified layer 42 at the predetermined depth inside the substrate 40, and so on, until the plurality of focused laser beams F split by the light splitting element 31 of the focusing lens set 30 together form the plurality of induce lines G1 spaced first interval W1 apart from each other and having the first laser modified cracks G2 in all positions (such as all rows in the X-axis direction) of the modified layer 42 at the predetermined depth inside the substrate 40.

Furthermore, as shown in FIG. 2B, FIG. 3B and step S2 of FIG. 4, the light splitting element 31 of the focusing lens set 30 is rotated with a predetermined angle (such as close to or equal to 90 degrees) by the rotating module 50, so that the plurality of focused laser beams F split by the light splitting element 31 of the focusing lens set 30 are converted into the plurality of modified groups H between the plurality of induce lines G1 of the modified layer 42 at the predetermined depth inside the substrate 40 according to the predetermined angle rotated by the rotating module 50, and each of the modified groups H comprises the plurality of modified lines H1 having second laser modified cracks H2 formed by the plurality of focused laser beams F of the light splitting element 31 of the focusing lens set 30, such that the first laser modified cracks G2 of the plurality of induce lines G1 and the second laser modified cracks H2 of the modified lines H1 of the plurality of modified groups H are connected to each other to together form a continuous laser modified crack in the modified layer 42 at the predetermined depth inside the substrate 40, until the plurality of modified groups H cover the whole layer surface of the modified layer 42. As explained above, the present disclosure does not limit the order of executing step S1 and step S2, that is, step S2 may be executed prior to step S1, or step S1 and step S2 may be executed concurrently. In the present disclosure, the layer surface of the modified layer 42 of the substrate 40 is covered with the plurality of induce lines G1 and modified lines H1 that are interlaced with each other, and there is an appropriate interval between the lines, so that the specially arranged modified pattern can also effectively increase the production speed of splitting.

That is, when the plurality (such as four) of focused laser beams F split by the light splitting element 31 of the focusing lens set 30 form the plurality of induce lines G1 spaced first interval W1 apart from each other and having the first laser modified cracks G2 (such as the bidirectional laser modified cracks) in the plurality of different positions (such as different rows in the X-axis direction) of the modified layer 42 at the predetermined depth inside the substrate 40, the rotating module 50 can rotate the light splitting element 31 of the focusing lens set 30 by a predetermined angle (i.e., an angle, a certain angle, a set angle, such as 90 degrees) according to the requirements of the laser slicing process or a predetermined rotation direction E (such as clockwise direction or counterclockwise direction), so that the plurality of focused laser beams F split by the light splitting element 31 of the focusing lens set 30 are converted from together forming the plurality of induce lines G1 (as shown in FIG. 3A) to together forming the plurality of modified groups H (as shown in FIG. 3B) between the plurality of induce lines G1 of the modified layer 42 at the predetermined depth inside the substrate 40 according to the predetermined angle (such as 90 degrees) rotated by the rotating module 50. At the same time, each of the modified groups H can comprise the plurality (such as four) of modified lines H1 having the second laser modified cracks H2 formed by the plurality (such as four) of focused laser beams F of the light splitting element 31 of the focusing lens set 30, so that the plurality (such as four) of modified lines H1 can be combined into the modified group H (i.e., multiple lines in one group), and two adjacent ones of the modified lines H1 can be spaced apart from each other by a predetermined second interval W2 (such as a second distance or a fixed distance), so that the first laser modified cracks G2 of the plurality of induce lines G1 and the second laser modified cracks H2 of the modified lines H1 of the plurality of modified groups H are connected to each other to together form a continuous laser modified crack in the modified layer 42 at the predetermined depth inside the substrate 40. In addition, the shapes of the first laser modified cracks G2 of the induce lines G1 and the second laser modified cracks H2 of the modified lines H1 can be the same or similar curved line, oblique line, S shape, regular shape, or irregular shape, etc. The above so-called first and second laser modified cracks G2 and H2 are naturally generated during the slicing process, and different intervals or processing conditions may produce differences in shapes or directions, but the present disclosure is not limited to as such.

Therefore, in the present disclosure, the laser slicing production rate of the modified layer 42 inside the substrate 40 can be increased by the light splitting element 31 of the focusing lens set 30, and the substrate 40 (the modified layer 42) may have a better (e.g., lower, smoother) surface roughness (e.g., Sa or Sz) via the plurality of induce lines G1, and the grinding and polishing loss of the substrate 40 (the modified layer 42) can also be reduced. In the aforementioned surface roughness of the substrate 40 (the modified layer 42), “Sa” and “Sz” may represent the “arithmetic mean height” and “maximum height” of the surface of the substrate 40 (the modified layer 42), respectively.

For example, as shown in FIG. 2B and FIG. 3B, the rotating module 50 can rotate the light splitting element 31 of the focusing lens set 30 by a predetermined angle (such as 90 degrees) according to the predetermined rotation direction E (such as clockwise direction or counterclockwise direction), so that the plurality (such as four) of focused laser beams F split by the light splitting element 31 of the focusing lens set 30 are used to synchronously form the plurality (such as four) of modified lines H1 having the second laser modified cracks H2 to form a modified group H between two adjacent ones of the induce lines G1 (as shown in the upper side of FIG. 3B), and then the plurality (such as four) of focused laser beams F split by the light splitting element 31 of the focusing lens set 30 are used to synchronously form the plurality (such as four) of modified lines H1 having the second laser modified cracks H2 to form another modified group H (as shown in the middle of FIG. 3B) between the other two adjacent ones of the induce lines G1, and so on, until the plurality of focused laser beams F split by the light splitting element 31 of the focusing lens set 30 form the plurality of modified lines H1 having the second laser modified cracks H2 to form the plurality of modified groups H between all of the induce lines G1, such that the first laser modified cracks G2 of the plurality of induce lines G1 and the second laser modified cracks H2 of the modified lines H1 of the plurality of modified groups H are connected to each other to together form a continuous laser modified crack in the modified layer 42 at the predetermined depth inside the substrate 40. The present disclosure does not limit the above-mentioned processing sequence of the induce lines G1 and the modified groups H or most of the modified lines H1. That is, if the focusing lens set 30 and the light splitting element 31 are properly arranged, for example, the focused laser beams F with different intervals can be processed synchronously.

Therefore, in the present disclosure, the growth or extension of the second laser modified cracks H2 (as shown in FIG. 3B) of the modified lines H1 of the plurality of modified groups H can be effectively guided or controlled by the first laser modified cracks G2 (as shown in FIG. 3A) of the plurality of induce lines G1, so that the first laser modified cracks G2 of the plurality of induce lines G1 and the second laser modified cracks H2 of the modified lines H1 of the plurality of modified groups H are connected to each other to together form a stable continuous laser modified crack in the modified layer 42 at the predetermined depth inside the substrate 40. That is, in the present disclosure, the growth direction of the second laser modified cracks H2 of the modified lines H1 of the plurality of modified groups H can be effectively guided or controlled by the first laser modified cracks G2 of the plurality of induce lines G1, so that the first laser modified cracks G2 and the second laser modified cracks H2 can be connected to each other to form a continuous laser modified crack, and the growth range or extension length of the second laser modified cracks H2 of the modified lines H1 of the plurality of modified groups H can also be effectively expanded or increased by the first laser modified cracks G2 of the plurality of induce lines G1, such that the laser slicing production rate of the modified layer 42 inside the substrate 40 can be increased, and the laser slicing time of the substrate 40 (the modified layer 42) or laser processing time can also be greatly reduced. At the same time, the present disclosure can effectively reduce the separation force or failure stress (such as the mechanical failure stress) of separating the thin slice 43 (as shown in FIG. 6) from the substrate 40 in subsequent processes (such as splitting and separation processes), and the present disclosure can also improve the split quality of the thin slice 43 of the substrate 40.

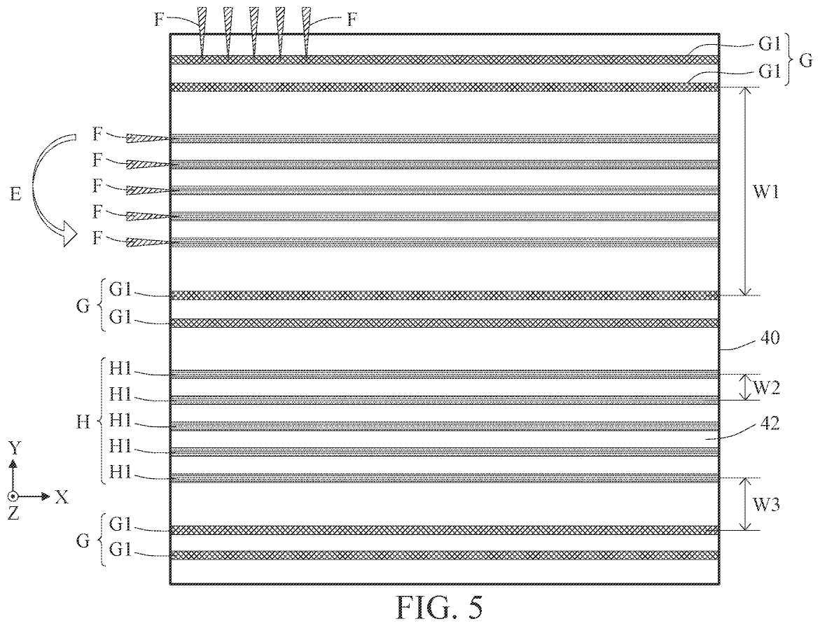

FIG. 5 is a schematic diagram illustrating another embodiment of the laser slicing apparatus 1 and method thereof shown in FIG. 2A to FIG. 2B of the present disclosure, and FIG. 5 shows that the plurality of modified groups H having the modified lines H1 (multiple lines in one group) are formed between the plurality of induce lines G1 by using the plurality of focused laser beams F, and the induce lines G1 and the modified lines H1 in FIG. 5 can respectively have the first laser modified cracks G2 and the second laser modified cracks H2 shown in FIG. 3B (not shown in FIG. 5).

As shown in FIG. 5 and the above-mentioned FIG. 2A to FIG. 2B, the plurality (such as five) of focused laser beams F split by the light splitting element 31 of the focusing lens set 30 can pass through the surface 41 (such as the upper surface) of the substrate 40 according to the vertical direction (such as the Z-axis direction), so that the plurality of focused laser beams F are successively (sequentially) focused on the plurality of different positions (such as different rows in the X-axis direction) of the modified layer 42 at the predetermined depth inside the substrate 40 according to the predetermined first interval W1, such that the induce lines G1 of induce groups G are successively (sequentially) formed in the plurality of different positions of the modified layer 42 at the predetermined depth inside the substrate 40 via the plurality of focused laser beams F. For example, the induce lines G1 of each of the induce groups G may comprise at least two (such as two, three, or four) induce lines G1, and each of the induce lines G1 may have the plurality of first laser modified cracks G2 (such as the bidirectional laser modified cracks) as shown in FIG. 3A to FIG. 3B.

Next, when the plurality (such as five) of focused laser beams F are split by the light splitting element 31 of the focusing lens set 30 to form the induce lines G1 of the induce groups G in the plurality of different positions (such as different rows in the X-axis direction) of the modified layer 42 at the predetermined depth inside the substrate 40, the rotating module 50 can rotate the light splitting element 31 of the focusing lens set 30 by a predetermined angle (such as 90 degrees) according to the predetermined rotation direction E (such as clockwise direction or counterclockwise direction), so that the plurality of focused laser beams F split by the light splitting element 31 of the focusing lens set 30 are converted from together forming the induce lines G1 of the induce groups G to together forming the plurality of modified groups H between the induce groups G according to the predetermined angle (such as 90 degrees) rotated by the rotating module 50, and each of the modified groups H may comprise the plurality (such as five) of modified lines H1 having the second laser modified cracks H2 formed by the plurality (such as five) of focused laser beams F of the light splitting element 31 of the focusing lens set 30, so that the first laser modified cracks G2 of the induce lines G1 of the induce groups G and the second laser modified cracks H2 of the modified lines H1 of the plurality of modified groups H are connected to each other to together form a continuous laser modified crack in the modified layer 42 at the predetermined depth inside the substrate 40. The number of the induce lines G1 of each of the induce groups G is less than the number of the modified lines H1 of each of the modified groups H. For example, the number of the induce lines G1 of each of the induce groups G is two or three, and the number of the modified lines H1 of each of the modified groups H is four, five, or six.

In addition, as shown in FIG. 2A and FIG. 3A, the focusing lens set 30 can be a focusing lens set with a numerical aperture (N.A.) greater than or equal to 0.4, so that the laser beam D provided by the laser module 10 can be formed as a focused laser beam F (such as a spot beam) by a focusing lens set having a numerical aperture (N.A.) greater than or equal to 0.4. Then, the focusing lens set 30 can split the focused laser beam F via the light splitting element 31 into the plurality of focused laser beams F, and the plurality of focused laser beams F can form a linear beam having a plurality of focal points (such as focused spots), and then the plurality of focal points (such as focused spots) of the linear beam are focused in the plurality of different positions of the modified layer 42 at the predetermined depth inside the substrate 40 so as to be connected and form the plurality of induce lines G1 having the first laser modified cracks G2, so that the laser slicing production rate of the modified layer 42 inside the substrate 40 can be increased by the light splitting element 31 of the focusing lens set 30, and the laser slicing time or laser processing time of the modified layer inside the conventional substrate can also be greatly reduced.

As shown in FIG. 3A, FIG. 3B, or FIG. 5, the first interval W1 between two adjacent ones of the induce lines G1 can be, for example, 350 microns (μm), etc., and the second interval W2 between two adjacent ones of the modified lines H1 can be, for example, 50-200 microns (μm), and a third interval W3 between the adjacent induce line G1 and modified line H1 can be, for example, 100-800 microns (μm), but the values of the first interval W1, the second interval W2 and the third interval W3 can be adjusted according to the laser slicing process of the substrate 40 (actual slicing requirements) or the number of the induce lines G1 (the modified lines H1), but the present disclosure is not limited to as such. For example, as the examples of FIG. 3A and FIG. 3B, assuming that the second interval W2 is 50 microns, and the third interval W3 is 100 microns and must be greater than the second interval W2, then three times the second interval W2 (such as 50 microns×3=150 microns) plus two times the third interval W3 (such as 100 microns×2=200 microns) is equal to 350 microns, so that the first interval W1 (such as the first distance or fixed distance) of for example 350 microns (μm) between two adjacent ones of the induce lines G1 is obtained.

As shown in FIG. 2B, FIG. 3B, or FIG. 5, in the modified layer 42 at the predetermined depth inside the substrate 40, the plurality of induce lines G1 having the first laser modified cracks G2 and the plurality of modified lines H1 (the modified groups H) having the second laser modified cracks H2 can all be located at the same level L (such as the same height, the same plane, and the same range) inside the substrate 40, so that the thickness of the modified layer 42 inside the substrate 40 can be greatly reduced or reduced to a minimum, and the grinding and polishing loss of the substrate 40 (the modified layer 42) can also be reduced, and a greater number of the thin slices 43 can also be separated from the substrate 40, but the present disclosure is not limited to as such.

The substrate 40 can be disposed on the transfer module 60, and the transfer module 60 can carry and move the substrate 40 to the corresponding plurality of focused laser beams F split by the light splitting element 31 of the focusing lens set 30, so that the plurality of focused laser beams F split by the light splitting element 31 of the focusing lens set 30 respectively form the plurality of induce lines G1 having the first laser modified cracks G2 in the modified layer 42 at the predetermined depth inside the substrate 40. Then, the plurality of focused laser beams F split by the light splitting element 31 of the focusing lens set 30 are converted into the plurality of modified lines H1 (the modified groups H) having the second laser modified cracks H2 respectively between the plurality of induce lines G1 of the modified layer 42 at the predetermined depth inside the substrate 40 according to the predetermined angle (such as 90 degrees) rotated by the rotating module 50, so that the first laser modified cracks G2 of the plurality of induce lines G1 and the second laser modified cracks H2 of the modified lines H1 of the plurality of modified groups H are connected to each other to together form the continuous laser modified crack in the modified layer 42 at the predetermined depth inside the substrate 40.

The control module 70 can integrate or control the laser module 10, the rotating module 50 and the transfer module 60, so that the laser slicing or laser processing can be quickly performed on the modified layer 42 (such as the entire modified layer) at the predetermined depth inside the substrate 40. For example, the control module 70 can follow the requirement of the laser slicing process of the substrate 40 (such as forming the plurality of induce lines G1 having the first laser modified cracks G2 or the plurality of modified lines H1 having the second laser modified cracks H2) to control the laser module 10 to emit the laser beam D to pass through the optical path conducting module 20 and the focusing lens set 30 having the light splitting element 31 in sequence, and the rotating module 50 can be controlled by the control module 70 to rotate the light splitting element 31 of the focusing lens set 30 to a predetermined angle (such as 90 degrees) according to the predetermined rotation direction E (such as clockwise direction or counterclockwise direction) to split the laser beam D into the plurality of focused laser beams F, and also the transfer module 60 can be controlled by the control module 70 to move the carried substrate 40 to the corresponding plurality of focused laser beams F split by the light splitting element 31 of the focusing lens set 30, so that the plurality of induce lines G1 having the first laser modified cracks G2 and the plurality of modified lines H1 (the modified groups H) having the second laser modified cracks H2 are formed by the plurality of focused laser beams F respectively to together form the continuous laser modified crack, thereby performing the laser slicing in the modified layer 42 at the predetermined depth inside the substrate 40.

FIG. 6 is a schematic diagram illustrating an embodiment of the laser slicing apparatus 1 (as shown in FIG. 2B) and method thereof of the present disclosure, and FIG. 6 shows that the thin slice 43 of the substrate 40 is separated from the modified layer 42 after forming the plurality of induce lines G1 and modified groups H (the modified lines H1) in the modified layer 42 at the predetermined depth inside the substrate 40 as shown in FIG. 3B.

As shown in FIG. 6, after the laser slicing apparatus 1 forms the plurality of induce lines G1 having the first laser modified cracks G2 and the plurality of modified lines H1 (the modified groups H) having the second laser modified cracks H2 to form a continuous laser modified crack in the modified layer 42 at the predetermined depth inside the substrate 40, in the subsequent process of the present disclosure (such as splitting and separation process), a splitting mechanism (such as a tensile tester) or a separation technology (such as a four-point bending technology) can be further used to separate the thin slice 43 and a portion 44 to be separated of the substrate 40 from the modified layer 42, and then a grinding and polishing process is performed on the plurality of induce lines G1 having the first laser modified cracks G2 and the plurality of modified lines H1 (the modified groups H) having the second laser modified cracks H2 in the modified layer 42 of the thin slice 43 and the portion 44 to be separated of the substrate 40, such that a greater number of the thin slices 43 can be repeatedly separated from the portion 44 to be separated of the substrate 40.

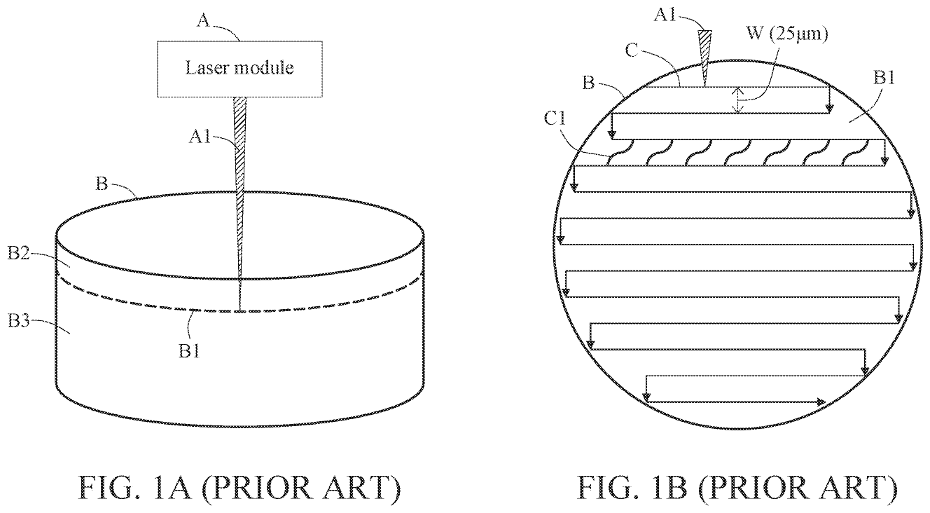

The results of the experiments or tests of the laser slicing apparatus 1 and method thereof of the present disclosure show that the required laser slicing time for performing the laser slicing to the modified layer 42 inside the substrate 40 (such as a 4-inch silicon carbide ingot) is only about 1.6 hours per slice. Therefore, compared with the general laser slicing technology shown in FIG. 1A to FIG. 1B where the laser slicing time required for laser slicing of the modified layer B1 inside the substrate B is about 10 hours per slice, the laser slicing apparatus 1 and method thereof of the present disclosure can increase the laser slicing production rate by 6.25 times (i.e., 10/1.6=6.25), so as to greatly reduce the laser slicing time of the modified layer B1 inside the substrate B.

In view of the above, the laser slicing apparatus and method thereof of the present disclosure have at least the following characteristics, advantages, or technical effects.
1. The laser module of the present disclosure can provide a laser beam to the light splitting element of the focusing lens set to be split into a plurality of focused laser beams, so that the plurality of induce lines having the first laser modified cracks can be formed in the modified layer inside the substrate, and then the plurality of modified lines having the second laser modified cracks and the modified groups (multiple lines in one group) can be formed between the plurality of induce lines according to the predetermined angle (such as 90 degrees) rotated by the rotating module, such that the combination of the laser module, the focusing lens set having the light splitting element and the rotating module can be properly used, thereby effectively increasing the laser slicing production rate of the modified layer inside the substrate.
2. The present disclosure can form (process) the plurality of induce lines having the first laser modified cracks via the plurality of focused laser beams in the modified layer at the predetermined depth inside the substrate to guide or control the growth of the laser modified cracks, and then the rotating module rotates the light splitting element of the focusing lens set to form (process) the plurality of modified lines having the second laser modified cracks and the modified groups (multiple lines in one group) via the plurality of focused laser beams to expand the extension of the laser modified cracks, so that a stable continuous laser modified crack can be formed at the modified layer inside the substrate, and the laser slicing time or laser processing time of the modified layer inside the substrate can also be greatly reduced.
3. The present disclosure can effectively guide or control the growth or extension of the second laser modified cracks of the modified lines of the plurality of modified groups via the first laser modified cracks of the plurality of induce lines, so that the first laser modified cracks of the plurality of induce lines and the second laser modified cracks of the modified lines of the plurality of modified groups can be connected to each other to form a stable continuous laser modified crack in the modified layer at the predetermined depth inside the substrate.
4. The present disclosure can effectively guide or control the growth direction of the second laser modified cracks of the modified lines of the plurality of modified groups by the first laser modified cracks of the plurality of induce lines, so that the first laser modified cracks and the second laser modified cracks can be connected to each other to form a continuous laser modified crack, and the growth range or extension length of the second laser modified cracks of the modified lines of the plurality of modified groups can also be effectively expanded or increased by the first laser modified cracks of the plurality of induce lines, such that the laser slicing production rate of the modified layer inside the substrate can be increased, and the laser slicing time or laser processing time of the substrate (the modified layer) can also be greatly reduced.
5. The present disclosure can effectively guide or control the growth of the plurality of first and second laser modified cracks in the modified layer at the predetermined depth inside the substrate via the plurality of induce lines to form a continuous laser modified crack. The present disclosure can also make the substrate (the modified layer) have a better (such as lower, smoother) surface roughness (such as Sa or Sz) via the plurality of induce lines, and the present disclosure can also reduce the grinding and polishing loss of the substrate (the modified layer).
6. In the present disclosure, the plurality of induce lines having the first laser modified cracks and the plurality of modified lines (the modified groups) having the second laser modified cracks can all be located at the same level (such as the same height, the same plane, the same range) inside the substrate, so that the thickness of the modified layer inside the substrate can be greatly reduced or reduced to a minimum, and the grinding and polishing loss of the substrate (the modified layer) can also be reduced, such that a greater number of thin slices can be separated from the substrate.
7. The control module of the present disclosure can integrate or control the laser module, the rotating module and the transfer module, so that the laser slicing (the laser processing) in the modified layer (such as the entire modified layer) can be quickly performed at the predetermined depth inside the substrate, such that the laser slicing production rate of the substrate can be increased, and the laser slicing time or laser processing time of the substrate (the modified layer) can also be greatly reduced.
8. In the present disclosure, the layer surface of the modified layer of the substrate is covered with the plurality of induce lines and modified lines that are interlaced with each other, and an appropriate interval is between the lines. Such a specially arranged modified pattern can also effectively reduce the force or failure stress of separating the thin slice from the substrate, and improve the split quality of the thin slice of the substrate.

The above embodiments are provided for illustrating the principles of the present disclosure and its technical effect, and should not be construed as to limit the present disclosure in any way. The above embodiments can be modified by one of ordinary skill in the art without departing from the spirit and scope of the present disclosure. Therefore, the scope claimed of the present disclosure should be defined by the following claims.

What is claimed is:

1. A laser slicing apparatus used to process a modified layer at a predetermined depth inside a substrate, the laser slicing apparatus comprising:
a laser module for providing a laser beam;
a focusing lens set having a light splitting element to split the laser beam into a plurality of focused laser beams for forming a plurality of induce lines on the modified layer; and
a rotating module used to rotate the light splitting element with a predetermined angle to form a plurality of modified groups on the modified layer by the plurality of focused laser beams, wherein any one of the modified groups is located between any two adjacent ones of the induce lines, each of the modified groups comprises a plurality of modified lines, and an interval (W2) is between any two adjacent ones of the modified lines.

2. The laser slicing apparatus of claim 1, wherein an interval (W3) is between any one of the induce lines and the adjacent modified line, and the interval (W3) is greater than the interval (W2).

3. The laser slicing apparatus of claim 1, wherein the focusing lens set has a numerical aperture greater than or equal to 0.4.

4. The laser slicing apparatus of claim 1, wherein the plurality of induce lines and the plurality of modified lines are parallel or nearly parallel to each other.

5. The laser slicing apparatus of claim 1, wherein the predetermined angle is about or equal to 90 degrees.

6. The laser slicing apparatus of claim 1, further comprising an optical path conducting module for conducting the laser beam to the focusing lens set.

7. The laser slicing apparatus of claim 1, further comprising a transfer module for carrying and moving the substrate to correspond to the plurality of focused laser beams.

8. The laser slicing apparatus of claim 7, further comprising a control module electrically connected to the laser module, the rotating module and the transfer module respectively.
